(19) United States
(12) Patent Application Publication
(10) Pub. No.: US 2008/0098417 A1
(43) Pub. Date: Apr. 24, 2008

(54) Viewer participatory television shows in conjuction with a system and method for real-time data collection and statistical assessment

(76) Inventors: Mehdi Hatamian, Coto De Caza, CA (US); Med Champ, Huntington Beach, CA (US)

Correspondence Address: STETINA BRUNDA GARRED & BRUCKER, 75 ENTERPRISE, SUITE 250, ALISO VIEJO, CA, 92656, US

(21) Appl. No.: 11/583,539

(22) Filed: Oct. 19, 2006

(51) Int. Cl. H04N 7/173; H04H 9/00; H04N 7/16; H04H 60/33

(52) U.S. Cl. 725/24; 725/9; 725/13

(57) ABSTRACT

A system and method for collecting data and statistically assessing such data for real time voting results. According to a preferred embodiment, input from a plurality of voters may be received through multiple modalities, namely, mobile/cellular phone networks, land line phone networks, set top boxes and/or the Internet. Voting data from each modality is received regionally and thereafter forwarded to a central vote processing location where statistical assessment and voting results may be generated in real time. In an alternative embodiment, the system and methods of the present invention can enable individual viewers to make selections on an individual basis, or autonomous groups may make selections on a group basis which in turn can be used in novel programming, VPTS, conducting polls, submission and acquisition of marketing/general data, RTCFA, or selecting any type of content options.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention is directed to systems and methods for collecting large amounts of data and performing a statistical assessment in relation thereto in connection with a real time voting system.

In today's digital world, the average person has many different means through which they may satisfy their entertainment needs. For instance, televisions, video games, the Internet, portable media players, cell phones are all examples of today's entertainment means. Although there is a vast array of entertainment means to choose from, each means presents a wide variety of options as well. For example, a video game player may choose from a number of different types of video games, e.g., sports-type, action, adventure, strategy, driving, puzzle, etc. In addition, the number of television channels and options has grown immensely with the advent of satellite, digital cable, TiVo, and Digital Video Recording (DVR). Audiences throughout the world are becoming increasingly more sophisticated, and competition for their time is growing. Shows that are capable of capturing large audiences are able to create an emotional attachment between the audience and the plot of the show. As entertainment options diversify, and audiences diverge towards niche programming, television networks strive to create shows that an audience will become emotionally attached to and thus, differentiate themselves from the competition.

Many shows create an emotional bond with their audience by developing a suspenseful plot that keeps the audience on the edge of their seat, waiting to find out what happens next. However, another way television networks have captured an audience is to allow the audience to vote for their favorite performer/cast member. Exemplary of such applications include reality television shows or televised competitions where viewers at home may tune into a television show that provides an option for voting for their favorite performer (i.e., American Idol), houseguest, or survivor. American Idol, for instance, one of the most popular shows in the United States, allows viewers from across the country to vote for their favorite performer. This level of audience participation creates an emotional attachment that draws the audience to the show. Audience members will watch the show to see if “their guy/girl” made the cut. Depending on the success of the show, tens of millions of votes may be cast for each episode. As such, votes must be collected and analyzed in a swift and efficient manner.

Systems for data collection and statistical assessment thereof for use in implementing such a voting system are well known. Voting options for such shows have become very popular and, as a result, enormous responses in terms of voter submissions must be accurately received and statistically assessed.

To that end, there are many well known methods in which voting may occur, with three popular systems in particular, including the Internet through e-mail, cellular and land line telephone system including text messaging in case of mobile phone networks, and cable set top boxes. These technologies have allowed viewers of major television shows to vote in mass in a very short period of time. Some major television shows can expect to receive 30 to 40 million votes through these various technologies in small time periods.

Generally, systems that are currently in place can handle approximately 30 to 40 million voters responses for a certain competition or show, which may take more than 10 hours to assess and process, and ultimately provide a statistically accurate result. Unfortunately, however, prior art systems are incapable of handling larger volumes of voter input data and further have limitations as to how many votes can be received in a given unit of time. As has been well-documented in recent seasons of the popular television show American Idol, oftentimes viewers wishing to input data cannot do so due to the inability of prior art systems to receive large volumes of voter input in short periods of time which in turn compromises voter results. It also makes viewers less likely to watch subsequent shows and participate in the future. In addition, there has not heretofore been available any type of methodology for collecting data and implementing a statistical assessment of the data for real time and fast voting applications. Moreover, there is a need for a system and method that can currently handle greater volumes of input from a plurality of voters in a voting population, as well as systems and methods that can handle greater amounts of volume in shorter amounts of time than prior art systems and methods. Still further, there is a need in the art for systems and methods for collecting data, and in particular voting data from a population of voters, and methods of assessing the statistical results thereof that are more accurate and reliable than prior art methods.

In addition, the success of shows enabling viewer participation, such as American Idol, has demonstrated that audiences want to participate and be involved in the show. As such, there is also a need in the art for a method and system for enabling a viewer to participate in selectively choosing the content of broadcast media, with real time viewer input, real time processing of that input, and real time feedback to the viewer.

### BRIEF SUMMARY

The present invention specifically addresses and alleviates the above-deficiencies in the art. In this regard, the present invention is directed to a system and method for data collection and statistical assessment of such data in real time for use in fast voting applications, regardless of the quantity of votes received. According to an aspect of the present invention, there is provided a data collection zone within which data, which will typically be related to a choice or selection, is collected. The data collection zone is comprised of at least two regions, wherein each region can comprise any discrete population whether it be by a population number, locale, or any other means by which one or more groups can be defined. Each region also includes a multiplicity of modalities through which voter data can be submitted by the individual participants in a voting population. Currently, it is contemplated that such modalities will include a means of transmitting data, such means being known or later developed, including, but not limited to, both mobile/cellular and land line phone networks, distribution appliances, including cable set top boxes and satellite set top boxes, and the Internet through which voters can submit their voter input via email.

Each modality transmits an input signal containing voter data. The input signal includes a destination address containing information corresponding to the specific option/selection made by the voter. The input signal is transmitted to a vote monitor module comprising at least one pre-programmed destination address. The vote monitor module is configured to receive the input signal and compare the destination address from the input signal with the pre-programmed destination address. After the input signals are received, a regional result is determined. The regional result is the number of input signals having a destination address identical to the pre-programmed destination address. The regional result is transmitted to a central vote processing location, where a final result is determined. The final result is the sum of the regional results. In other words, all of the regional results are tallied to determine a final result.

According to various embodiments of the present invention, the input signal may include a source address containing voter identification information. The source address may be used to prevent voters from voting twice. An input signal containing an identical source address to an earlier received vote, or an input signal from outside the specified data collection zone, may be blocked; for example, not counting votes from unauthorized area codes. The source address may also be useful for advertising and marketing purposes. The input signal may be generated in a number of different ways. For instance, the input signal may be generated by voice dialing from a telephone system, or text messaging from a mobile phone network. The input signal may also be generated from a distribution appliance, such as a cable or satellite set top box, or it may be generated by email. The input signal may also be generated by other methods and devices known by those skilled in the art.

According to another embodiment of the present invention, the vote monitor module may be attached to various communication systems to accommodate the plurality of modalities. For instance, the vote monitor module may be attached to a central switch for land line phone networks in a particular area. Additionally, the vote monitor module may be attached to a base station for mobile phone networks in a particular area.

As was mentioned, the data is collected from within a data collection zone. The size and location of the data collection zone may vary according to different embodiments. For instance, the data collection zone may be defined as, but is not limited to time-zone boundaries or country boundaries. In the case of time zone boundaries, the data collection zone may be defined as the Pacific Time Zone. Each data collection zone includes at least two regions. Therefore, the Pacific Time Zone would be comprised of at least two regions.

According to another aspect of the present invention, there is provided a system for data collection and statistical assessment for real time applications. The system includes an input transmitter for transmitting an input signal having a destination address to the regional modality. The system also includes a vote monitor module having a pre-programmed destination address. The vote monitor module is capable of receiving the input signal and comparing the input signal destination address with the pre-programmed destination address. A regional processor determines a regional result at each vote monitor module. The regional result is the number of input signals having a destination address identical to the pre-programmed destination address. A regional transmitter transmits the regional result to a central vote processing location. Once transmitted to the central vote processing location, a central processor determines a final result. The final result is the sum of the regional results.

The invention can advantageously provide real time results because of its ability to distribute the method of collecting votes and the realization that a single destination address need be detected. Although the method is applicable for various voting systems, it may prove to be the most advantageous for a voting system where the majority of votes are from mobile phones due to the fact a huge population carries a mobile phone or has immediate access to one. Such is not the case for land line phones, Internet access, or even distribution appliances. Typically, using a mobile phone as a voting device is very simple. For real time and fast voting applications the two major factors for implementation are a distributed and parallel method of vote collection and the detection of a single destination address.

In another aspect of the invention, the various modalities through which voter input may be transmitted and received may further be utilized for use by individual viewers of programming having selectively variable content. In this regard, it is contemplated that the systems and methods of the present invention can enable individual viewers to watch programming and choose specific types of content that will be incorporated into the programming. Accordingly, a method and system for enabling a viewer to participate in selectively choosing the content of broadcast media is provided. The method includes providing media having at least two content options. The content options may include, but are not limited to, a choice between different people, places, things, actions, routes, events, thoughts, etc. The media is broadcast into a data collection zone. The media is displayed on a viewing device, which may include, but is not limited to a television, portable media device, movie screen, monitor, or computer. The viewer is then provided with an opportunity to choose a content selection. The content selection is the preferred content option of the viewer. A content selection signal containing the content selection is transmitted to the broadcast center. The content selection signal contains data including the content selection of the viewer. A final content option is then broadcast. In this regard, the final content option is one of the at least two content options.

As was stated above, it is intended that the present invention may be used to allow viewers within the data collection zone to participate in selectively choosing the content of the broadcast media. According to an embodiment of present invention, the final content option that is broadcast may vary. In one embodiment, the final content option may be the option selected by a majority of viewers within a broadcast zone. In another embodiment, the final content option may be the option selected by each individual viewer.

According to various embodiments, the selection signal may be generated using a number of different modalities, or input devices. For instance, the selection signal may be generated by voice dialing from a telephone system, by a text message from a mobile phone network or by an e-mail. The selection signal may also be generated by a distribution appliance, such as a cable set top box, or satellite set top box. Other modalities known by those skilled in the art may also be used to generate the selection signal.

In this respect, it is contemplated that the systems and methods of the present invention can enable viewers to choose a variety of content options at different points of a program, such as the ending of a movie or otherwise determine the fate of one or more characters. Accordingly, it is contemplated that the present invention offers the possibility of having the voting points available from the first, second, and to the last second of the program. Additionally, the present invention offers the possibility of having multiple voting points during every act. As a consequence, the viewer will be empowered to control programming content so as to have the desired ending or otherwise have one of a variety of particular types of endings. Therefore, the viewer will thus be afforded multiple ways to enjoy a particular program and thus leave different dramatic impressions and the like.

According to another aspect of the present invention, there is provided a method for enabling a voting population to participate in selectively choosing the content of broadcast media. Media having at least two content options is provided to a viewing population. A plurality of modalities is provided such that each member of the voting population may transmit an input signal. The input signal contains the selection choice of each voter. A vote monitor module receives the input signal. After receiving an input signal, a final content option is broadcast.

It is contemplated that the voting population may vary. It may be defined to include one person, or alternatively a large group of people, such as the population of an entire country. Examples of voting populations include, but are not limited to the passengers on an airplane, the students in a classroom, or the audience in a movie theater. The input signal transmitted from each voter may be transmitted via a wireless module. In the case of an airplane, the wireless transmitter must use an approved frequency for use on a plane while in the air.

### BRIEF DESCRIPTION OF THE DRAWINGS

These and other features and advantages of the various embodiments disclosed herein will be better understood with respect to the following description and drawing, in which like numbers refer to like parts throughout, and in which:

FIG. 1 is a flow chart diagram illustrating a method for data collection and statistical assessment for real time voting results;

FIG. 2 is a flow chart diagram illustrating a method enabling an individual viewer to select the specific type of content to be incorporated within the programming that is broadcast to the viewer;

FIG. 3 is a diagram of a distributed architecture of a cellular network, including mobile phones, base stations and a cellular network center; and

FIGS. 4a-4e outline an overview of Viewer Participatory Television Shows (VPTS) Technology, otherwise known as the Fast Voting System.

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

The present invention advantageously allows a far greater volume of voter data to be received than prior art systems, especially with regard to the ability to handle larger volume of voter input per unit of time than prior art systems. By being able to do so, the systems and methods of the present invention are capable of providing faster, more accurate voting results that can be readily accessed in real time. The systems and methods of the present invention have particular application for use in television shows, and in particular reality-based contest shows such as American Idol, and the like, where it is ideal to receive votes, opinions and other information from viewers who are solicited to provide votes, opinion data, and the like. Other applications may include news reporting shows, wherein a poll may be conducted among the viewing public. For example, a news station or network may take a poll among voters to determine the political climate in a given area. Among such applications include but are not limited to presidential speeches, presidential debates, town hall meetings, during guest interviews, during news stories, or during live news events.

To achieve that end, and based upon technology currently in use, there are three popular systems through which most viewer voting occurs, namely: 1) the Internet, typically through votes made by e-mail; 2) the telephone system through voice dialing on land lines or both voice dialing; and 3) text messaging in the case of mobile phone networks, and cable set top boxes.

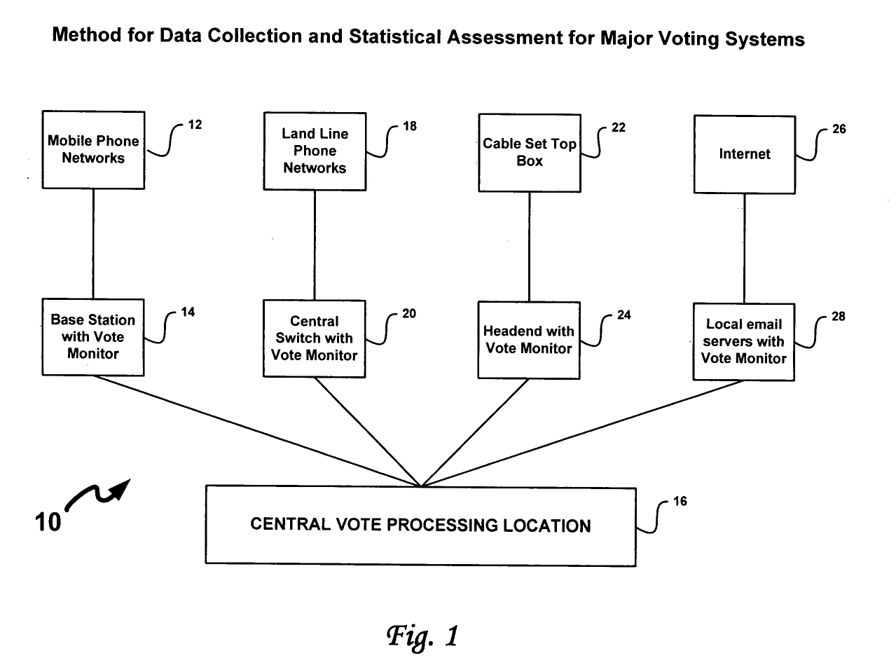

The present invention is directed to a system and method for collecting data, and in particular voting data received from a voting population, and statistically assessing such data in real time to provide highly accurate voting results, regardless of the quantity of votes received. According to an aspect of the present invention, there is provided a data collection zone within which data, which will typically be related to a selection or choice, is collected. The data collection zone is the entire area over which a particular ballot is cast. The data collection zone is comprised of at least two regions, wherein each region can comprise any discrete population whether it is by a population number, locale, or any other means by which one or more groups can be defined. Currently, it is contemplated that such modalities will include known means of transmitting data, or later developed means of transmitting data including, but not limited to, both mobile/cellular and land line phone networks, distribution appliances, such as cable and satellite set top boxes, and the Internet through which voters may transmit their selection. Each modality includes an input transmitter for transmitting an input signal. The input signal comprises a destination address containing voter selection information. The input signal is received at a vote monitor module. The vote monitor module receives the input signal and compares the input signal destination address with a vote monitor module pre-programmed destination address. The number of input signals having a destination address identical to the pre-programmed destination address is the regional result. After the regional result is tabulated, it is transmitted to a central vote processing station, where a final result is determined. The final result is simply the sum of the various regional results. The system and method for providing real time and fast voting applications for each major system is discussed below, and shown in reference to FIG. 1.

FIG. 1 illustrates the method for data collection and statistical assessment for major voting systems. Due to the large number of mobile phone users, the mobile phone network 12 is a popular means for casting a vote. Generally, the voter is required to vote for one of at least two options A or B, although it is understood that there is no limit as to the number of options that may be present to each voter. Each voting option is assigned a dedicated phone number. For example, if the viewer at home has three choices for picking his or her favorite performer, then each choice will have a distinct phone number. The voter dials the particular phone number corresponding to the option he/she desires to select and therefore sends his or her selection, typically by pressing the phone's send key. The phone number dialed by the voter is the input destination address. The destination number is transmitted to the nearest base station 14 in the mobile phone network. In this case the destination number is one of the pre-assigned numbers for the different voting options.

Each base station 14 will include hardware known as the vote monitor module. The vote monitor module may be integrated into a chip, which can be easily placed in every base station 14. The vote monitor module includes a pre-programmed destination address. The vote monitor module may be programmed remotely by the phone company. In the case of a telephone system, the pre-programmed destination address is a particular phone number that is assigned to the different voting options to be selected by the voters. The input to the vote monitor module is the input destination address detected by the nearest base station 14. The vote monitor module will compare the destination address it receives as input with the pre-assigned destination address. If there is a match with any of the voting options, a vote counter that corresponds to the choice is incremented. In this respect, if there are N choices then there will be N voting counters and N comparators working in parallel.

According to an embodiment of the present invention, the input signal may also include a source address. As used herein, the source address contains voter identification information. In the telephone system described above, the source address would be the phone number of the voter. The source address of each voter may be stored in a particular memory block. Because phone numbers are unique in identifying a registered user, the information that the voting monitor hardware collects can be authenticated. For example, if a voter calls in for the second time during a voting period, the hardware can compare the number against all numbers stored in its source number memory block and if it already exists, it will be discarded and not counted as a vote. Alternatively, if voters are allowed to vote more than once, the source number memory block can store the number of votes made by a specific source number.

It is contemplated that each voter will cast his/her vote during a voting time period. At the end of each voting time period, each voting monitor hardware module will have the exact number of votes for each choice including a table of phone numbers identifying the voters contributing to each of the choices. The table of phone numbers may be useful for advertising purposes, and will be discussed in more detail below. Because the voting process ends at each base station without any further action and propagation to other destinations, all the votes from one entire data collection zone are essentially collected in real time. This takes place in real time without delay as the votes are entered during the voting period. At the end of the voting period, the voting monitor hardware at each base station transmits its vote counts to a central vote processing location 16 to tally the votes. For example, if there are 5000 base stations in one zone and three choices to vote for, the total amount of data to arrive at the central vote processing location is no more than 15,000 count numbers which can be transmitted and received almost instantaneously. Instead of routing all the vote calls and text messages to a central vote processing location and jamming the network, as utilized with prior art systems, the processing is done in a distributed and parallel manner.

According to an aspect of the present invention, the size and location of the data collection zone may vary. Along these lines, it is contemplated that the present invention may be applied to any region, which is defined herein as any discrete population whether it be by a population number, locale, or any other means by which one or more groups can be defined. It is understood that in the United States, most television programming is broadcast uniformly throughout each time zone. Therefore, various embodiments of the present invention may include a data collection zone defined as an entire time zone. Thus, as a program is broadcast in a particular time zone, all of the viewers within that time zone can vote at the same time. However, sometimes a network will decide to broadcast a show across multiple time zones at the same time. For instance a show may be broadcast across the United States at one particular time, e.g. 9 p.m. eastern time, 8 p.m. central time, 7 p.m. mountain time, and 6 p.m. pacific time. In that case, it may be beneficial to define the data collection zone as the entire country. The data collection zone may be varied to include smaller or larger areas, zones, or districts depending on the application. It should be understood that the present invention expressly contemplates the ability to selectively block any region at any time during a specific voting event, which can include limiting the duration individual(s) in a given region can submit choice or selection data, such as a vote or the like. For example, it is contemplated that the present invention may allow for single source input and/or selectively restrict one or more modalities through which input may be transmitted.

The text messaging method of voting follows the same procedure described above. The source and destination phone numbers are received and handled in the same manner as a voice call. The “land line” network 18 works identical to the mobile phone networks 12 except that the voting monitor hardware 20 is installed at a central switch 20 locations instead of base stations 14 used for mobile phone networks 12.

A further voting method through which voter input may be transmitted is through a distribution appliance. Distribution appliances are capable of receiving a signal and displaying the content of that signal on a viewing device, such as a television. Distribution appliances include, but are not limited to set top boxes, such as cable set top boxes, satellite set top boxes, and FiOS set top boxes, and further can include game consoles, DVD players, and any other set top box known in the art and as may be later developed. FIG. 1 shows a cable set top box 22. Cable set top boxes 22 are typically equipped with upstream data transmission capabilities that allow choices and selections to be transmitted to the particular cable network headend 24 that provides the service (e.g., such as pay per view movies, sporting events, concerts, and the like).

The distributed vote collection mechanism described above can also apply to distribution appliances. An input signal having a destination address is sent from the distribution appliance to the vote monitor module. The distribution appliance system uses a vote monitor module that is added to a headend 24, rather than a base station 14 as described above in relation to the telephone system. The vote monitor module compares the input signal destination address with the pre-programmed destination address and tabulates a regional result. The regional result is then transmitted to the central vote processing location where a final result is computed.

As was mentioned above, the input signal may include a source address in addition to a destination address. In the distribution appliance system described above, the source address may contain information specific to each distribution appliance. For instance, information specific to a cable set top box 22, may be used to identify the registered household.

Finally, the third major voting system is the Internet 26. The voting takes place via e-mails sent to pre-assigned e-mail addresses wherein each voting option will have one e-mail address also called the destination address. Again, the distributed method described above can also be used here except that instead of the base station used for mobile phone networks, local e-mail servers 28 distributed throughout the world are used. Additionally, instead of a source and destination phone number, source and destination e-mail addresses are used.

As discussed above, regardless of the modality through which voter input is transmitted, whether it be through a mobile phone network 12, land line phone network 18, cable set top box 22, the Internet 26, and/or some other type of modality, all voter data will essentially be collected regionally and thereafter transmitted to a central vote processing location 16. By collecting voter data via a plurality of modalities on a regional basis, the systems and methods of the present invention are capable of handling far greater volumes of voter input than prior art methods. In this respect, prior art methods that use a centralized approach to receiving all types of voter input cannot accommodate high volume or high traffic data input. As a consequence, voters are often unable to input their voting data, due to an inability to successfully transmit their vote. Moreover, because of the inability of centralized systems to handle such large volumes of voter input, the accuracy of voter results is often compromised, thus providing inherently unreliable results. The present invention, in contrast, eliminates such disadvantages and further can provide real time statistical assessment by virtue of the aforementioned. techniques through which data is received, namely, on a regional basis whereby the input can be consistently and accurately received and assessed in real time.

As a further advantage of the present invention, there may be obtained information regarding the viewing population, and in particular the phone numbers, household demographics, and the like as may be derived from informational data submitted by the voting population. For example, particular phone numbers from which voting input originate will be indicative of the fact that the cell phone user views a particular broadcast. The same rationale also applies to email addresses and votes submitted through set top boxes, which in turn can be utilized to implement effective advertising and marketing campaigns through techniques well-known in the art. Such data may further be useful in determining and assessing media viewership results, such as television ratings and the like, to determine a particular television show's popularity and the specific demographic that such television show attracts. Accordingly, in addition to the foregoing advantages with respect to accurate assessment of voting data in real time, the systems and methods of the present invention may find widespread application in a variety of other areas.

In addition to the foregoing, it is expressly contemplated that the systems and methods of the present invention may find widespread applicability to not only use in voting applications, but may further be implemented to enable a viewer to make selections pertaining to the content of programming and the like. With the proliferation of personal computers, cell phones, digital cable, and portable media players, in homes across the world, audiences have become more sophisticated. As such, an aspect of the present invention aims at providing a method and system for enabling a viewer to participate in selectively choosing the content of broadcast media. By giving the viewer the option of selectively choosing the content of a show, the viewer becomes emotionally attached to the show. This results in a larger, more dedicated audience.

According to an aspect of the present invention, there is provided a method and system for enabling a viewer to participate in selectively choosing the content of broadcast media. The media is broadcast from a broadcast center into a data collection zone comprised of at least two regions. The media includes at least two content options that a viewer may select from, and will be referred to herein as Viewer Participatory Television Shows (VPTS). As the VPTS is displayed on a viewing device, the viewer is presented with an opportunity to choose a content selection. As used herein, the content selection is the preferred content option of the viewer. The viewer then transmits a content selection signal to the broadcast center. The content selection signal includes the content selection of the viewer. After receiving the content selection signal, a final content option is broadcast. The final content option is one of the at least two content options presented to the viewer.

VPTS allows the greatest possible license for surprises, variability, and unconventional storytelling. It permits deviations from traditional organizations of structure, as well as applications of literary devices. For example, having an episode in the sports genre told from the first person perspective of Athlete A (narrator), and then enabling the audience to choose another athlete on the team, either Athlete B or Athlete C, to take over the role of narrator for the whole remainder of the program. Thus, the audience leaves Athlete A to function independently, and witnesses the decisions made by Athlete B or Athlete C resulting in a positive or negative outcome for A, the original protagonist. This one example, alone, represents a fundamental shift in the structural arrangement of plots for television movies and episodes.

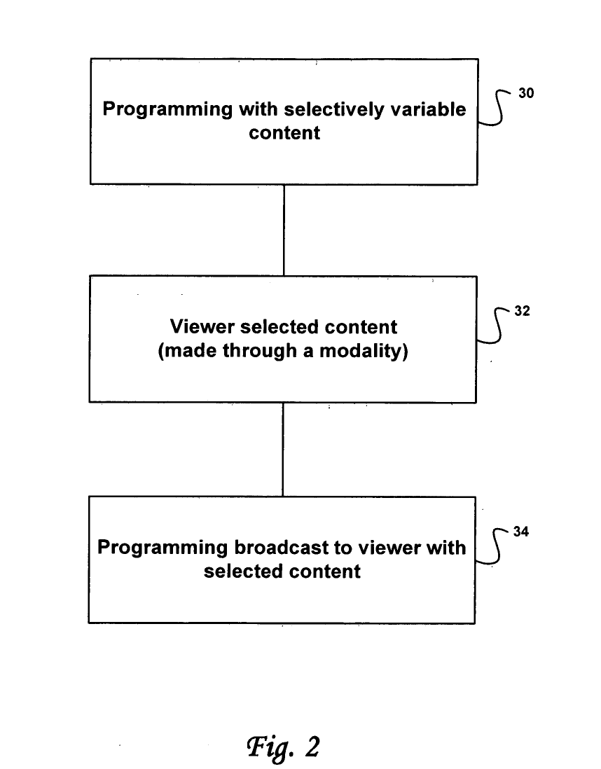

FIG. 2 is a flow chart diagram illustrating the above described method. Box 30 indicates that programming with selectively variable content is provided. Such programming will have at least two content options. During the course of the program, the viewer is provided with an opportunity to make a content selection, which is illustrated as Box 32. In other words, the viewer is given an opportunity to selectively choose between at least two different content options. After the selection is made, programming is broadcast to the viewer with selected content, as shown in Box 34.

In this particular application, it is contemplated that the present invention can be applied to options that can be decided almost instantaneously. For example, the viewer may be given the option to make a choice among persons, places, things, actions, routes, events, and thoughts, to name a few. In one such application, it is contemplated that the viewer may utilize the systems and methods of the present invention to select the direction and content of a particular program, such as the particular type of ending and the like. For example, a movie, situation comedy, or the like may be provided with multiple endings and the viewer may be afforded the option to select a particular type of ending depending on the viewer's preference. In such application, the viewer may thus be able to dictate whether or not the outcome has a happy or sad ending, the ultimate fate of the characters is resolved according to a certain plot, and/or if some other conclusion can be reached. To facilitate that end, it is contemplated that the individual viewer may be provided with a multiplicity of endings or resolutions to a specific type of program and, through simply making a selection via the aforementioned modalities can, practically up to the very last second, decide the type of ending the individual prefers as the programming is broadcast to the viewer that incorporates the viewer's selected content.

As a consequence, the individual viewer can essentially play the role of director and actually be afforded the ability to experience a specific type of programming that has a particular type of ending that can be selectively chosen. Along these lines, it is expressly contemplated that the ability of an individual viewer to select a particular type of ending from these two choices will thus enable the individual to see the same type of programming multiple times and thus experience different endings, which in turn will provide substantially different questions and entertainment experiences.

As was described above, the viewer chooses a content selection and transmits a content selection signal. The content selection signal is similar to the input signal as described above in that it may be generated by a number of different modalities. For example, the content selection signal may be generated by a distribution appliance, such as a cable or satellite set top box, by voice dialing from a telephone system, by text messaging from a mobile phone network, by email, or by other methods and devices known or later developed by those skilled in the art. The content selection signal may also include a source address containing voter identification information.

However, before a viewer can make a content selection, the viewer must be presented with an opportunity to make such a selection. Therefore, the programming must include at least two content options. In order to have programming including at least two content options, both options must be created. In other words, there must be a script for each content option that is presented and each content option must be shot and edited. Even though only one content option may be broadcast, all options must be created. The following is an example of a VPTS script for a pilot episode offering two content options.

Pilot Mini-Movie Treatment for:

“Viewer Participatory Television Shows”

Created & Written by Med Champ

Palm Valley Productions

Broadcast Network Prime Time

Genre: Adventure-Comedy

Mini-Movie Title: Nevada Falls

(Introductory Segment Begins)

A “Blue Screen” appears, and a “Female Computer Voice” presents the “VPTS ” voting rules and procedures.

The “VPTS” host walks into a room, and introduces the story.

(Introductory Segment Ends)

Flashes of bright light. A fierce storm erupts over murky, dark blue heavens. We see crackling bolts of electricity strike the wide open fields of a Central California college campus, in the county of Merced.

Near campus. The next morning the suns penetrating rays slowly part the clouds. We see a shiny, white sport utility vehicle in the driveway of an apartment building. Out of the darkness of the garage walks Ronny, affable psychology major, in his early twenties. He opens the rear door, tosses in a backpack Up walks Vince, a tall lanky African-American English major in his early twenties. Vince jokes, “You weren't going to leave without me, were you? Cause I wouldn't miss this if my life depended on it.” He throws his pack in the rear. They enter the SUV and drive off

On surface streets. The two engage in conversation about the hiking trip to Yosemite National Park, and the recent strain Ronny and his girlfriend, Kate, have had in their relationship. Ronny describes her as uncompromising, “tough as nails.” They pull up to the entrance of Kate's apartment. Ronny dials her up on his cell phone. Kate, pretty, red headed business major in her early twenties, steps out the front entry; shouldering her pack She hustles down, hops into the back seat, and remarks, “I heard El Capitan is a pretty big rock.” They zoom off onto Highway 140. After a minute Vince holds his stomach and appears queasy. He asks Ronny to pull over immediately. The SUV comes to a stop, Vince flies out, sprints over to a ditch near the highway, and throws up. Kate voices concern about Vince's condition, and Ronny tells her not worry. In the background we can hear Vince throwing up. Ronny continues to explain that they had a jalapeno eating contest the night before, and Vince won, hands down.

Vacant road running by the side of a mountain. We see a prison bus, filled with inmates wearing orange jumpsuits, handcuffed to their seats. In the drivers cabin Guard #1 sits behind the wheel. Guard #2 stands holding a railing, casually gazing out the window at the passing wilderness. Sitting in the front row, by the aisle, is one inmate: Baron, dashing, handsome fellow with blonde hair, in his early forties. Baron chats with Guard #1, who comments that Baron 's demeanor gives no hint of the flagrant crimes he's committed over the years. During the discourse we see Baron stealthily pull out a small metal object from his jumpsuit. In silent fashion, he unlocks himself. Then, deposits two effervescent tablets into his mouth, and starts choking Foam gushes and streams down his chin. Guard #2 unlocks the barrier door, steps into the aisle. Baron leaps up, pivots, and elbows Guard #2, knocking him unconscious against a railing. He proceeds to grab Guard #1, flip open the door, and powerfully hurl him outside. Guard #1 spins in the air, hits the ground with a thud, and barrels over the pavement. The other inmates cheer in unison, and boisterously demand to be unlocked. Baron halts the bus on the edge of the road, turns around, grins. He pulls the baton from the limp body of Guard #2, and wedges it between the seat and gas pedal. Baron wishes everyone adieu, puts the bus in gear, and leaps out the door. His exit occurs just as it starts to edge over a cliff and down the side of the mountain. The inmates scream in horror. One yells in panic. “Oh my God we're all going to die!” The bus tips over the edge and starts to roll over towards a thousand foot drop. Unexpectedly the bus collides against an embankment with a giant thud, and rests in an almost vertical position. The inmates let out a collective sigh of relief Baron sluggishly rises up, dusts himself off, looks down at the bus, and remarks, “Damn! I missed.” He disappears into the woods. Another inmate protests, “I'm going to write the Governor about this!”

Entrance to Yosemite National Park Ronny is at the wheel, while Vince is sound asleep. Kate and Ronny have a conversation about college life, and problems in the world at large. Ronny takes out his MP3 player and selects a neoclassical-pop vocal track The vehicle weaves around the winding road, advancing past cars on the right lane of the road. They pull into Yosemite Valley. Ronny asks his sleeping friend a rhetorical question. “So Vince, can you manage to contain your excitement?” Vince snores. Ronny replies, “That's what I thought.” The SUV pulls into an area densely surrounded by Sequoia trees. Thick branches block the sun, causing looming shadows. Suddenly without warning, a loud popping sound emanates from under the car. The left front tire begins to wobble. Vince wakes up. Ronny pulls into a rest area, and gets out to discover a blown tire. The music track steadily fades out.

Lake near Yosemite West. Heavy metal music blares in the background as two men dressed in camouflaged outfits sit on a dock and fish. Their red pickup truck is loaded with camping equipment. The men talk boisterously and toast their soda cans. Two motorbikes are parked near the road. Baron slowly, deliberately, emerges from the backside of the bushes. Hidden behind the foliage, he calmly surveys the area.

Entrance to Yosemite National Park Ronny and Vince have trouble changing the flat. In frustration, Kate picks up the jack, vigorously pumps the tire up. Ronny and Vince are both stunned and impressed by the display. Kate hastily puts them to work giving curt instructions on how to properly fasten the spare tire on to the vehicle. As Vince works to change the flat, he loses his balance and trips backwards into a mud pile, landing on his butt.

Back at the lake near Yosemite West. Quietly creeping over to the pickup, Baron rummages through one of the duffle bags. Flashing a sinister smile, he locates the object of his search. Baron flings one of the bags over his shoulder, proceeds over to the bikes, and leaps on board one. With smug satisfaction, he revs the engine, causing enough resonance to get the attention of the two men. Startled and wild-eyed, they drop their rods and sprint after him in protest. Baron shifts the motorbike in gear, speeds off down the road, leaving a cloud of dust that obscures the two men.

Main road in Yosemite Valley. The SUV pulls up to a parking area. The trio get out to stretch. Ronny points out El Capitan. We see a towering monument overlooking the park Vince, in jest, proposes they attempt to climb it. Ronny takes out a map and presents their destination. He points out the exact route they'll follow to the east end of the valley, then the hike up the trail to Nevada Falls. Ronny and Kate have a tense exchange, and debate a possible breakup. Vince serves as mediator and convinces them to call a truce, before the couple reluctantly returns to the car. Ronny gets into the drivers side, and turns the ignition switch.

A back road. Baron whizzes down the pavement at high velocity, the wind blowing through his hair. He pulls over and leads the bike into the thicket, all the while talking with himself about his good fortune at having escaped. A signpost declares the location as the south side of Nevada Falls. Out of the bag he extracts a Bowie knife with an extended handle. Then he picks up what appears to be a hand gun, but upon closer scrutiny turns out to be a flare gun. Baron swears, angrily tosses it into the bag. He withdraws some clothes and begins to change.

On the trail. Ronny, Kate, and Vince traverse up the dirt path, hauling their packs. Vince is out of breath. He relates how his schedule of constant study hasn't allowed adequate time for exercise. Vince sits on a fallen tree, pulls out a satellite radio from his back pack, and announces that he needs to check the score of the Knicks/Bulls basketball game. To the chagrin of Vince, the sportscaster relays the Knicks losing score. Just before he clicks off the radio, the report of the prison bus incident comes on. Vince summons the other two over to listen in. A newscaster recounts that the location of the perpetrator is currently unknown. Ronny encourages Vince to get moving. States he is sure to regain his strength when they attain the summit of the trail.

As Vince starts to rise, Ronny looks up, stunned. Vince inquires about the curious expression on his face, and Ronny points behind him. Vince slowly turns around to see an enormous mountain lion creeping towards them. Vince and Kate start to run, but Ronny is frozen stiff Kate calls back, pleading with Ronny to get moving, but without success. The lion positions itself to spring. Kate rushes back, scoops up a rock. The mountain lion leaps up, as Kate hurls the rock, hitting it smack in the rear end, and knocking it over. It immediately retreats up the hillside. Kate gives Ronny a disgusted look and states, “That's really weak.” Then, she shakes her head and continues up the trail.

A Campsite. Tents litter a circular field, as four Boy Scouts work to pile tree logs. Scout #1 is eating a giant chocolate bar. He instructs the other three to make haste, so they can catch up with the rest of the party that has already departed to go rowing on a lake. Scout #2 repeatedly sneezes next to Scout #3, causing him to drop the logs on his own foot. From behind a tent, Baron casually steps out, dressed as a genuine forest ranger. The three boys are startled and Scout #4 drops another log on the foot of Scout #3. Baron picks up a paddle and menacingly suggests they rejoin their group, but asks Scout #1 to stay behind. When the two are alone, Baron grabs the chocolate bar, startling Scout #1. Baron instructs him to run away as fast as possible, and Scout #1 flees without hesitation. Baron loudly warns that he will come looking for all of them, when he finishes devouring the chocolate bar. Standing at the center of the campsite, Baron chuckles and takes another bite.

Top of Nevada Falls. Dim, hazy clouds converge together, shrouding the sun. We see a vacant soulless plateau. Ronny, Kate, and Vince sluggishly arrive and deposit their packs in an area near the edge of the cliff They setup the picnic area. Ronny points out a group of squirrels scampering around, chasing each other. The critters spot something at the edge of the clearing and quickly scurry off Out from the thicket appears Baron. Attached to one side of his belt is the large knife, and to the other, the flare gun. Baron strolls over towards the group in a congenial manner, introduces himself, and starts a conversation with a false accent. After noticing some rumbling in his stomach, Vince inquires about the location of an outhouse near the area. Baron points him several hundred yards down the opposite trail. Ronny decides to escort Vince, leaving Kate and Baron alone.

A police chopper in the air above Yosemite. A radio dispatcher relays a report of the stolen motorbike to the pilot. He receives coordinates for the direction of the escaped inmate. The pilot confirms his response to the call. The chopper changes course, and conducts a sharp slanting 110 degree turn.

Top of Nevada Falls. Strolling along the edge of the cliff, Baron provides Kate a contrived explanation of the natural surroundings. They arrive near the falls. Kate comments on the extended drop, while peering at the powerful torrent pouring down the rock face. Baron alludes to the bus incident, and the good fortune of one of the prisoners, who managed to escape. She suspiciously questions the source of his information. Baron shrugs it off and asks to borrow her cell phone. Kate reaches into her pocket and hands it over. He fumbles with it, loses his grip. The phone plops into the water. It descends down the side of the falls, smashes against the wall, and in midair, flips open.

Down the trail. Ronny and Vince have been traversing for a while, without any sight of the outhouse. They halt and confer with one another. Ronny calls Kate's cell phone. There's no answer. The two give each other concerned looks, and conclude that Baron's story doesn't add up. They quickly realize they are on a wild goose chase. Ronny decides they better return to the summit of the falls without delay.

Top of Nevada Falls. Baron describes the ominous, long drop downwards. As he speaks, the false accent begins to vanish. Kate stares at him with trepidation. Baron winks, then lunges, grabbing her by the arm. Kate slaps him. Baron, embodying a state of aggravation, brandishes the Bowie knife. She, rushes forward, catches him by surprise, and delivers a round house kick to the stomach. In pain, Baron stumbles around. A heart pounding struggle takes place. Kate manages to bite Baron's arm, forcing him to drop the knife near the edge of the cliff. At that very moment, Ronny and Vince arrive on the scene. In a burst of strength, Baron shoves Kate. She screams, and stumbles over the precipice next to the falls. Vince immediately rushes Baron and tackles him. An altercation ensues. Ronny skids over to the edge, and witnesses Kate barely grabbing hold of a protruding rock. She strains, struggling to grasp on for dear life.

(Voting Segment Begins)

“Blue Screen” appears. A “Female Computer Voice” presents the following two options on the screen:

Option #1—Ronny attempts to save Kate from falling, leaving Vince to fight Baron alone.

Option #2—Ronny joins Vince in fighting Baron, hoping Kate can maintain her hold on the rock.

At center of the screen, 60 second countdown clock commences, indicating time remaining to vote. Viewers vote.

(Voting Segment Ends)

Commercial break.

(Winning option for the respective Time Zone-Region is broadcast.) . . .

Voting Option #1—Resolution Ronny yells at Kate, imploring her to hold on. He looks back at Vince and Baron, in a deadlock, throwing fists back and forth. Then he reaches for Kate's hands, manages to grab hold of her left, causing her right to slip. Kate loses her fragile grip on the rock, and dangles from Ronny's arm. Vince has Baron on the ground, in a sleeper hold. Baron feints weakness, but jabs Vince's eyes and twists out. Ronny starts pulling Kate up. Just before she approaches the ledge, he loses his footing and they both slide forward. Kate bounces off the rock. Their hands break apart and she drops, sliding, diving into the water below. Ronny is shocked, and shouts in protest after Kate. He turns around to see Baron and Vince in a rough scuffle near the falls. Baron knocks Vince to his knees. Then he heaves forward, pushing Vince off the summit and down the gushing torrent. Ronny is infuriated. He grabs the knife off the ground, runs straight for Baron. As Ronny makes a stabbing motion, Baron turns, and trips him. Ronny skips over the edge, losing the knife. He barely snatches on to a mass of roots sticking out from the dirt. The sound of chopper blades can be heard in the distance, hovering in the sky. Baron calls out and waves to Kate and Vince, who are slowly crawling onto shore. He then peers down at a distraught Ronny. Baron shrugs his shoulders, and retreats into the woods. The police chopper arrives overhead. The pilot reports back to dispatch, that he can discern what appears to be a person hanging next to Nevada Falls. The roots break off Ronny plummets into the water with a whopping splash.

Voting Option #2—Resolution Ronny yells at Kate, imploring her to hold on. He looks back at Vince and Baron, in a deadlock, throwing fists back and forth. He instructs Kate to remain calm and breath, then looks around the area. Out of the corner of his eye, Ronny spots the knife, and reaches for it. In one swooping motion he stabs it downward at a 45 degree angle, just above the rock that Kate is clasping on to. She immediately seizes on to it and finds a footing. Vince has Baron on the ground, in a sleeper hold. Baron feints weakness, but jabs Vince's eyes and twists out. Ronny directs Kate to hang on a little longer, rolls around, and gets up. He runs headfirst into Baron, tackling him to the ground. The flare gun gets loose and goes flying out of its holster, next to Vince, who is still recovering from the jab. Ronny and Baron are exchanging blows, as Vince reaches for the flare gun. Vince shouts at Ronny to hit the deck Ronny dives in-between Baron's legs, and ties his arms around them. Vince sits up, dazed, points the flare gun, and presses the trigger. Ronny lets go, just as the discharged round nearly connects, forcing Baron over the edge. The round explodes in a magnificent burst in the air, as Baron splashes into the water at the base of the falls and disappears. The sound of chopper blades can be heard in the distance, hovering in the sky. Later, we see the chopper flying by the majestic heights of El Capitan. Inside, next to the pilot, sits an exhausted Vince. Ronny and Kate, in the back, apologize to each other and embrace. Vince turns around and asks if they believe Baron survived the drop down Nevada Falls. Ronny and Kate stare at each other in silence.

As can be seen from the script, VPTS aims at creating the greatest dramatic impact, meaning attaining both the strongest immediate and lingering emotional involvement from the audience during the program. The audience will first have to decide whether Ronny goes to rescue Kate, or whether he joins Vince in fighting Baron. At this point, the audience becomes emotionally involved with the characters. The audience is aware that Ronny can only aide one person at a time; either Kate or Vince. The audience's selection will determine the outcome, thereby maximizing the dramatic effect.

Although choosing between at least two different options will have the greatest dramatic impact, the timing of the balloting window will also provide additional dramatic impact. As used herein, the balloting window is the length of time allotted for the audience to make their choice, and electronically submit their content selection. In other words, the placement of the balloting window within the show will also add to the dramatic effect. Not having knowledge of the precise moment the voting period beings elevates the suspense level.

In the case of a program having only one content selection opportunity, the timing of the voting period may provide even more suspense. Having the voting period or periods appear at different parts of the show may alter the complexion of the program. For instance, having the voting point during the first ⅓ of the act allows for a gradual development of the plot line to its conclusion, with the audience watching the choice they have made result in consequential actions over a relatively long period of time. Having the window emerge during the second ⅓ of the act positions the audience to make a decision based on information they have gathered after watching a portion of the denouement. Having the final ⅓ of the act contain this point amplifies the tension, supplies the most narrative data before the final route is chosen, and results in an immediate crescendo.

As described above, the method and system of the present invention may be used to broadcast VPTS into a data collection zone. According to various embodiments of the present invention, the size and area of the data collection zone may vary. The data collection zone may be varied to include any region or area. For instance, in one embodiment, the method and system may be used to broadcast VPTS into an entire time-zone region. According to another embodiment, the data collection zone may be defined by country boundaries. Prime time network broadcasts are oftentimes broadcast at different times in different time zones, as such, it may be beneficial to define the data collection zone by time zone boundaries. The following will describe one approach of implementing VPTS programming into prime time network television.

The prime time broadcasts of VPTS programming, utilizing the voting selection method on a major broadcast television network and viewed through a variety of distribution appliances is known as the first run. During the first run of a VPTS show, the viewers will have an opportunity to make at least one content selection during the course of the program. At the end of the second act, or during the third act of each episode, the viewers have a brief balloting window (e.g. 1 minute) to choose from at least two possible pre-shot “routes” the characters, or protagonists, can take to resolve the conflict; the outcome being either positive or negative or neutral. A family or group that watches together, may conduct an informal internal poll before submitting their content selection, thus, setting the stage for an even more absorbing and dramatic experience. The informal internal poll includes the discussion or debates a family or assemblage viewing VPTS programming engage in to gauge opinions and preferences. This heightens the emotional involvement of the members before the choices are made and the outcome is determined. Viewers then cast their votes via the modalities discussed above (e.g. text messaging, voice dialing, email, set top box, etc.).

According to various embodiments of the present invention, the broadcast center may vary the broadcast of the final content option. The broadcast center may broadcast the final content option based on voting selection. Voting selecting is where an entire voting population within the data collection zone selects the winning option. When using voting selection, whichever option garners the largest percentage vote is the option that is broadcast. This provides the most suspense and drama because each viewer knows that their vote counts, and that they will only see one content selection. As such, it may prove to be more beneficial to broadcast the content selection receiving the most votes during the first run. However, according to another aspect of the present invention, the broadcast center may broadcast the final content option based on individual selection. Individual selection allows each individual to control the selection of the content option they would like. The decision as to which option to select may be determined by a consensus of more than one person, however a single individual must ultimately input the selection. Therefore, in this embodiment, it would not matter what the majority of the time-zone region selected. Although, the viewer may be presented with the results of the time-zone region to see what the majority of the time-zone region was interested in viewing.

After the first-run has been broadcast, post-run versions of each VPTS show may become available. According to one embodiment, consumers will be able to purchase an entire “season” of VPTS shows on DVD. Consumers may have a strong motivation to purchase the DVD season sets in order to see the alternative versions they missed during the network broadcasts. To satisfy that demand, the DVD set may include both “cuts” of each episode. This may create an entirely new dynamic if voting selection was used in the first run because an individual viewer with a remote control may now personally decide the outcome, as opposed to an entire data collection zone. Digital cable, Internet, and portable media player users may purchase or order single episodes with both “cuts” also available, and enjoy the same option of personally selecting a route.

VPTS may also provide additional channels through which advertisers and marketers reach their target audience. Advertisers may grasp onto VPTS in order to maximize the effectiveness of their marketing campaigns in today's oversaturated media environment. For instance, product placement may seamlessly play an integral part in both the story and voting dynamic of VPTS. In fact the respective item or items inherently create unique plot configurations and lead to situations that the consumer can positively identify with. The product fills a key role, and is in many respects a vital aspect of the show. The following is an example of Real-Time Consumer Feedback Advertising (RTCFA). There may be an episode where the hero of the show is chasing after his nemesis. At a critical juncture of the chase, the nemesis obtains a superior mode of transportation, one that the hero does not seem able to match. At this moment, the viewer may be presented with an opportunity to make a choice. The audience can choose for the hero to commandeer one of two automobiles. Not only are the two choices displayed in text for the viewer, but three-dimensional rotating images of the vehicles are also shown, along with verbal descriptions of each choice. Both automobiles are from the same manufacturer, and both scenarios yield a favorable outcome. This serves to ensure that positive impressions for both products are imparted upon the audience.

The remainder of the program showcases the winning options for each time-zone region. The last minute swerve into an alley or leap over a ramp to catch the nemesis fulfills the requirements for the story, and provides the automobile with unique character traits. The incorporated emotional resonance creates a vibrant and established consumer perception of the brand identity before they visit the dealer showroom or retailer. This distinct delivery and consumer feedback system, operating in real-time, cannot be replicated with commercials, promotional videos, or other forms of advertising. Through RTCFA, virtually any type of product can fit into the VPTS system and gain immense recognition that would otherwise be difficult to obtain.

The audience is placed in control, leaving the rest to “natural selection.” Using RTCFA, advertisers can verifiably gauge on a massive scale the audience's appetite and/or preference for products before they are even available for purchase. The exposure and identification from product placement, advertising, and RTCFA on VPTS translates into unparalleled financial benefits for the contributing entities.

Although various embodiments of the present invention have been described above in the context of network television, there may be other useful applications. For instance, according to another aspect of the present invention, there is presented a method for enabling group selection. As used herein, group selection enables group members to participate in selectively choosing the content of media having at least two content options. The group members include those viewers capable of casting a vote or making a content selection option. According to various embodiments, the group members may include different groupings of people. For example, the voting population may include, but is not limited to, the passengers on an airplane, or students in a classroom, or audience in a movie theater, as illustrative, non-limiting examples. Furthermore, the number of people included in the voting population may also vary. For instance, the voting population may be as small as one person, but can be as large as desired. According to the type of group, the input signal may be generated by transmission devices known in the art. For example, as was mentioned above, due to their current popularity, cell phones may be used. However, a wireless module capable of transmitting either A/B choices or text to a central receiver could also be used. In the case of having a voting group on an airplane, if a wireless signal is used to carry the voter input, the frequency of the wireless module would have to be an approved frequency for use in the plane while in the air.

The following is a glossary of terms used herein and associated with the methods and systems described above:

“VPTS” Glossary & Definition of Terms

1) Viewer Participatory Television Shows (VPTS)—premium content created to provide mainstream entertainment that engages the audience in real-time.

2) Premium Content—high quality entertainment that is readily accessible and affordable for the global marketplace.

3) Pre-Shot—previously produced and recorded content.

4) Real-Time—in computing (not media) terms, the instantaneous transmission, processing, and accessibility of data, that is required for VPTS. For example, the real-time capabilities of the Fast Voting System allow for the creation of numerous applications.

5) First-Run—the prime time broadcasts of VPTS programming, utilizing the Voting Selection method on a major broadcast television network, and viewed through a variety of distribution appliances.

6) Post-Run—the distribution window (that is indefinitely open) after the prime time broadcast within which a Mini-Movie or episode is available for order or purchase, and viewed through a variety of distribution appliances.

7) Time Zone-Region—a regionally assigned geographic border within a time zone. (Designated on a case-by-case basis.)

8) Viewer Selection—the all-inclusive term used to encompass all methods and modes audiences utilize to input their selection data.

9) Voting Selection—an entire Time Zone-Region selects the winning Option. This is determined by whichever Option garners the largest percentage vote.

10) Individual Selection—an individual person is in control of selecting the Option they would like. The decision as to which Option to select may be determined by a consensus of more than one person, however a single individual must ultimately input the selection.

11) Group Selection—an autonomous group, in an isolated environment such as with an in-flight showing, selects the winning Option. This is determined by whichever Option garners the largest percentage tally.

12) VPTS Menu Screen—the graphical user interface of VPTS programming that audiences interact with, during both the First-Run and Post-Run.

13) Options—the particular choices (i.e. A or B) audiences have to vote/individual/group select.

14) Voting Point—the exact point during the running time of a program, in which the VPTS Menu Screen appears to the viewer, and the Options are available for Voting Selection.

15) Balloting Window—the length of time allotted for the audience to make their choice, and electronically submit their preference during Voting Selection of the network broadcast.

16) Ballot—the authorized data that the viewer inputs into the Fast Voting System during the Balloting Window of the VPTS Voting Selection process.

17) Branching—the divergence of the narrative into two lines. The determining factor as to which line the viewer or viewers will follow to the end of the running time is decided by the Option winner during the vote/individual/group selection process.

18) Winning Branch—the line that was vote/individual/group selected. All VPTS Post-Run programs include both Branches of each episode.

19) Informal Internal Poll—the discussion or debate a family or assemblage viewing VPTS programming, during the First-Run or Post-Run, engage in to gauge opinions and preferences. This heightens the emotional involvement of the present members before the choices are made and the outcome determined.

20) Rooting Interest—the emotional attachment of the viewer to the characters and plot of VPTS programming, in such a way as to elicit the viewer to want a particular outcome to the course of events.

21) Mini-Movie Series—movies created specifically for VPTS but with a relatively shorter running time than traditional fare, and spanning any genre.

22) Episodic Series—series created specifically for VPTS within a specific genre, with a single premise, and containing a recurring cast of characters.

23) Real-Time Consumer Feedback Advertising (RTCFA)—a distinct delivery and consumer feedback system designed specifically for VPTS and the Fast Voting System, that provides unique and innovative ways to market products and services.

24) “Phase 1 of VPTS”—the initial worldwide production and distribution offering of VPTS programming.

25) Fast Voting System—a method that uses a distributed scheme to detect and collect votes, and a central scheme to process votes. Thereby, enabling the execution of Real-Time applications.

26) Vote Monitor Modules (VMM)—the installed hardware (i.e. at Base Stations) that is required for fast vote collection.

27) Distribution Sources—Originating signal from Broadcaster, Station, Server, Host, etc.

28) Distribution Agents—Sent through Cable, Satellite, FiOS, and Internet through various networks. Encompasses both wired and wireless transmissions.

29) Distribution Appliances—Using Set Top Box (i.e. Cable, DVR, etc), Modem, Router, DVD Player, Video Game Console, etc.

30) Distribution Outlet—Reception by way of Airing, Lines, VOD, Pay-Per-View, Recorded, Downloads, Streaming, etc. as experienced through Television, Computer, Portable Media Player, Cell Phone, Radio, or other Electronic Device.

31) Voting Selection is linked to Distribution Sources and Distribution Agents

32) Individual Selection may be either linked or not linked to Distribution Sources and Distribution Agents.

33) Group Selection may be either linked or not linked to Distribution Sources and Distribution Agents.

34) Voting Selection—Vote; an example includes casting a vote during the balloting window of a time-zone region broadcast using text messaging on a Sprint cell phone.

35) Individual Selection—Pick; an example includes making a pick on an Apple Video iPod.

36) Group Selection—Tally; an example includes accumulating the tally from passengers on a single American Airlines flight.

37) Palm Valley Productions—the entity formed with the purpose of creating innovative content and technologies for the entertainment enjoyment of audiences in the 21st century and beyond.

While illustrative and present embodiments of the invention have been described in detail herein, it is to be understood that the inventive concepts may be otherwise variously embodied and employed. It should further be understood that the invention described herein may be utilized in a wide variety of applications that will be readily appreciated by those skilled in the art.

1. A method of data collection and statistical assessment for real time applications, the data being collected from within a data collection zone comprised of at least two regions, the method comprising the steps of:
a. transmitting an input signal having a destination address, the signal being transmitted to a vote monitor module comprising at least one pre-programmed destination address;
b. receiving the input signal at the vote monitor module, the vote monitor module configured to receive the input signal and compare the destination address from the input signal with the pre-programmed destination address;
c. comparing the input signal destination address with the pre-programmed destination address;
d. determining a regional result, the regional result being the number of input signals having a destination address identical to the pre-programmed destination address;
e. transmitting the regional result to a central vote processing location; and
f. determining a final result, the final result being the sum of the regional results.

2. The method of claim 1 wherein the input signal also includes a source address.

3. The method of claim 2, further comprising the step of blocking an input signal having a source address identical to the source address of an already received input signal.

4. The method of claim 1 wherein the input signal is generated by voice dialing from a telephone system.

5. The method of claim 4 wherein the destination address is a destination phone number.

6. The method of claim 1 wherein the input signal is generated by a text message from a mobile phone network.

7. The method of claim 1 wherein the input signal is generated by a distribution appliance.

8. The method of claim 7 wherein the distribution appliance is a set top box.

9. The method of claim 8 wherein the set top box is a cable set top box.

10. The method of claim 8 wherein the set top box is a satellite set top box.

11. The method of claim 8 wherein the set top box is a FiOS set top box.

12. The method of claim 1 wherein the input signal is transmitted across the Internet.

13. The method of claim 12 wherein the destination address is a destination e-mail address.

14. The method of claim 1 wherein the data collection zone is defined by country boundaries.

15. The method of claim 1 wherein the data collection zone is defined by time zone boundaries.

16. The method of claim 4 wherein the vote monitor module is attached to a central switch for land line phone networks.

17. The method of claim 4 wherein the vote monitor module is attached to a base station for mobile phone networks.

18. The method of claim 12 wherein the vote monitor module is attached to email servers for Internet networks.

19. A system for data collection and statistical assessment for real time applications, the data being collected from within a data collection zone comprised of at least two regions, the system comprising:
an input transmitter for transmitting an input signal having a destination address;
a vote monitor module having a pre-programmed destination address, the vote monitor module capable of receiving the input signal and comparing the input signal destination address with the pre-programmed destination address;
a regional processor for determining a regional result at each vote monitor module, the regional result being the number of input signals having a destination address identical to the pre-programmed destination address;
a regional transmitter for transmitting the regional result to a central vote processing location; and
a central processor for determining a final result, the final result being the sum of the regional results.

20. The system of claim 19 wherein the input signal also includes a source address.

21. The system of claim 19 wherein the input signal is generated by voice dialing from a telephone system.

22. The system of claim 21 wherein the destination address is a destination phone number.

23. The system of claim 21 wherein the vote monitor module is attached to a central switch for land line phone networks in a particular area.

24. The system of claim 19 wherein the input signal is generated by a text message from a mobile phone network.

25. The system of claim 24 wherein the vote monitor module is attached to a base station for mobile phone networks.

26. The system of claim 19 wherein the input signal is generated by a distribution appliance.

27. The system of claim 26 wherein the distribution appliance is a set top box.

28. The system of claim 27 wherein the set top box is a cable set top box.

29. The system of claim 27 wherein the set top box is a FiOS set top box.

30. The system of claim 27 wherein the set top box is a satellite set top box.

31. The system of claim 19 wherein the input signal is transmitted across the Internet.

32. The system of claim 31 wherein the destination address is an e-mail address.

33. The system of claim 31 wherein the vote monitor module is attached to an email server for Internet networks in a particular area.

34. The system of claim 19 wherein the data collection zone is defined by time zone boundaries.

35. The system of claim 19 wherein the data collection zone is defined by country boundaries.

36. A method for enabling a viewer to participate in selectively choosing the content of broadcast media, the media being broadcast into a data collection zone, the method comprising:
a. providing media having at least two content options;
b. displaying the media on a viewing device;
c. choosing a content selection, the content selection being the preferred content option of the viewer;
d. transmitting a content selection signal to a broadcast center, the content selection signal including the content selection; and
e. broadcasting a final content option, the final content option being one of the at least two content options to the viewing device.

37. The method of claim 36 wherein the content selection is made during a balloting window, the balloting window being a specific length of time within which the viewer chooses a content selection.

38. The method of claim 36 wherein the content selection signal includes a source address.

39. The method of claim 36 wherein the content selection signal is generated by voice dialing from a telephone system.

40. The method of claim 36 wherein the content selection signal is generated by a text message from a mobile phone network.

41. The method of claim 36 wherein the content selection signal is generated by a distribution appliance.

42. The method of claim 41, wherein the distribution appliance is a set top box.

43. The method of claim 42 wherein the set top box is a cable set top box.

44. The method of claim 42 wherein the set top box is a FiOS set top box.

45. The method of claim 42 wherein the set top box is a satellite set top box.

46. The method of claim 36 wherein the content selection signal is transmitted across the Internet.

47. The method of claim 36 wherein the data collection zone is defined by country boundaries.

48. The method of claim 36 wherein the data collection zone is defined by time zone boundaries.

49. The method of claim 36 wherein the final content option is the option selected by each viewer.

50. The method of claim 36 wherein the final content option is the option selected by a majority of viewers within the data collection zone.

51. A system for enabling a viewer to participate in selectively choosing the content of broadcast media having at least two content options, the media being broadcast into a data collection zone, the system comprised of:
a selection device capable of generating a selection signal, the selection signal containing a destination address;
a vote monitor module having a pre-programmed destination address, the vote monitor module capable of receiving the selection signal and comparing the destination address with the pre-programmed destination address;
a processor for determining a final result, the final result being the number of selection signals having a destination address identical to the pre-programmed destination address; and
a broadcast device for broadcasting a final content option, the final content option being one of the at least two content options.

52. The system of claim 51 wherein the selection signal includes a source address.

53. The system of claim 52, further comprising the step of blocking a selection signal having a source address identical to an already received selection signal.

54. The system of claim 51 wherein the selection device is a telephone capable of generating a voice signal.

55. The system of claim 51 wherein the selection device is a mobile phone capable of generating a text message.

56. The system of claim 51 wherein the selection device is a distribution appliance.

57. The system of claim 56 wherein the distribution appliance is a set top box.

58. The system of claim 55 wherein the set top box is a cable set top box.

59. The system of claim 55 wherein the set top box is a satellite set top box.

60. The system of claim 55 wherein the set top box is a FiOS set top box.

61. The system of claim 51 wherein the selection device is capable of generating an e-mail.

62. The method of claim 51 wherein the selection device is capable of generating an Internet signal.

63. The system of claim 51 wherein the data collection zone is defined by at least two regions.

64. The system of claim 51 wherein the region is defined by country boundaries.

65. The system of claim 51 wherein region is defined by time zone boundaries.

66. The system of claim 51 wherein the final content option is the option selected by each viewer.

67. The system of claim 51 wherein the final content option is the option selected by a majority of viewers within the data collection zone.

68. A method for enabling a voting population to participate in selectively choosing the content of broadcast media, the method comprising:
a. providing media having at least two content options;
b. providing a plurality of modalities through which members of the voting population may transmit an input signal;
c. transmitting an input signal by each voting member of the voting population;
d. receiving the input signal at a vote monitor module; and
e. broadcasting a final content option, the final content option being one of the at least two content options.

69. The method of claim 68 wherein the voting population includes passengers on an airplane.

70. The method of claim 68 wherein the voting population includes students in a classroom.

71. The method of claim 68 wherein the voting population includes an audience in a movie theater.

72. The method of claim 68 wherein the voting population includes one individual.

73. The method of claim 68 wherein the input signal is transmitted via a wireless module.

74. The method of claim 68 wherein the media is Viewer Participatory Television Shows.

75. The method of claim 68 wherein the media is Real-Time Consumer Feedback Advertising.
